(19) United States
(12) Patent Application Publication
(10) Pub. No.: US 2005/0098086 A1
(43) Pub. Date: May 12, 2005

(54) Tactile guidance system

(76) Inventor: Jacqueline Anne Moore, Chesterfield (GB)

Correspondence Address: WOODARD, EMHARDT, MORIARTY, MCNETT & HENRY LLP, BANK ONE CENTER/TOWER, 111 MONUMENT CIRCLE, SUITE 3700, INDIANAPOLIS, IN, 46204-5137, US

(21) Appl. No.: 10/989,134

(22) Filed: Nov. 15, 2004

Related U.S. Application Data
(63) Continuation of application No. 10/187,576, filed on Jul. 2, 2002, now abandoned.
Application No. 10/187,576 is a continuation-in-part of application No. 09/489,843, filed on Jan. 24, 2000, now abandoned.

(30) Foreign Application Priority Data
Jan. 24, 2000 (WO) PCT/GB00/00151
Jan. 27, 1999 (GB) 9901632.1

(51) Int. Cl. G01D 13/22

(52) U.S. Cl. 116/205

(57) ABSTRACT

A tactile guidance system is provided comprising a plurality of tactile indicators in a first form located at pre-determined spaced intervals along a surface to mark a route to be followed by a user to a particular location. The user moves towards the particular location by following the tactile indicators using a sensory part of their body. One or more further tactile indicators are provided in at least a second form on the surface. The tactile indicators in the second form indicate to a user that they are required to change their direction of movement and move in a new direction in order to reach the particular location. Once the user has changed their direction of movement accordingly, the user then continues to follow further tactile indicators of said first or further form to the particular location.

This invention relates to a tactile guidance system, and particularly but not exclusively to a tactile guidance system to allow a user to be directed along a route within a building, vehicle or premises. The route can be to an exit, collection point, emergency equipment or any pre-determined location as required.

The user of directional signs such as exit signs are well known and are an adopted method of directing people towards stairways and safe exit points during everyday use and in the case of an emergency, such as in the event of a fire. These signs can be in the form of a visual aid, such as an image or text or can be in the form of a tactile aid, such as one or more tactile markers which a user is required to follow.

A problem associated with visual aids is that they rely on a person exiting the building, vehicle or premises to understand the language of the text or the image on the sign. This is not always the case, particularly when the aids are provided in locations where a wide variety of people of different nationalities, ages and agilities are likely to use them. In addition, although exit signs are often illuminated to assist safe exit in low light situations, the signs can still be difficult to see in certain situations, such as in dense smoke and are not useful for blind people or people with poor eyesight.

Tactile aids provided either independently or in addition to lighting can be used allow a person to be directed to an exit irrespective of the visibility within the premises, the ability of the person to understand a particular language or particular images and/or how good the person's eyesight is. For example, U.S. Pat. No. 5,626,094 discloses the provision of a tactile indicator provided on a handrail at the top or bottom of a flight of stairs to indicate to a user that there is a flight of stairs above or below them and/or that they have reached the top or bottom of the flight of stairs. However, such a tactile indicator is only of limited use since it does not provide information to allow a user to find an exit or take a particular route of travel.

An example of a tactile aid used to provide information to allow the user to find an exit to a building is disclosed in GB2224154. The tactile guidance aid comprises a plurality of serrations or bumps attached to a surface, which are provided substantially continuously along an exit route, thereby allowing a user to follow the same to an exit. A different type of serration or bump is provided at the end of a line of indicators to mark the end of the route to inform the user that they have reached the exit. The disadvantage of this guidance aid is that it can only be used in a continuous line of the same form of serrations terminating in an end serration which is of different shape. As such, this aid does not allow a user to find an exit if the route to the nearest exit involves a user having to cross a corridor or choosing one of a number of corridors.

U.S. Pat. No. 6,025,773 provides one such system where the guidance aid is at or adjacent the floor in an attempt to allow a user to cross a corridor or area which does not have a vertical wall to locate a guidance aid thereon. The disadvantages associated with the guidance system of U.S. Pat. No. 6,025,773 are that the person is required to be in a prone position in order to follow the symbols. This is not always possible for certain users, such as disabled users, elderly or frail users, or users in wheelchairs. In addition, as the different directional symbols are provided on different supporting mediums, the user is required to fumble around when one set of symbols finish to find where the next set of symbols begin. This is likely to be difficult and time consuming, thereby delaying the persons exit from the premises.

It is therefore an aim of the present invention to provide a tactile guidance system which overcomes the abovementioned problems.

According to a first aspect of the present invention there is provided a tactile guidance system, said tactile guidance system comprising, a plurality of tactile indicators in a first form located at pre-determined spaced intervals along a surface to mark a route to be followed by a user to a particular location, the user moving towards the particular location by following the tactile indicators using a sensory part of their body, and wherein one or more tactile indicators are provided in at least a second form on said surface, the tactile indicators in said at least second form indicating to a user that they are required to change their direction of movement and move in a new direction in order to reach said particular location.

Typically, if the route to be followed incorporates at least one turn or change in direction to be made, the tactile indicators in said at least second form are located an interspersed within the route defined by the tactile indicators, such that the user follows the first form of indicators, encounters the second form indicators, changes their direction of movement/travel accordingly and then encounters more of said first indicators to reach said particular location, or comes across further indicators of second form, changes direction and so on.

Preferably the tactile indicators of said first form have one or more features which are clearly and easily distinguishable from the tactile indicators of said at least second form.

In one embodiment the new direction of movement involves the user releasing their contact with the tactile indicators and moving in a required direction, for example moving across free space such as across a corridor or door way, until they make contact with further tactile indicators. In one embodiment the second form of tactile indicators includes an indicator as to the required change of direction to be made or alternatively this is provided in instructions given to personnel, i.e., change direction, or turn through 90 degrees and/or the like.

Preferably the tactile indicators in said first and at least second forms are provided, where possible, substantially continuously along the surface on the route of travel/movement required to reach the particular location from any other pre-determined location.

The pre-determined spaced intervals of the tactile indicators are a sufficient distance apart to allow a user to distinguish a tactile indicator from its adjacent tactile indicators, whilst limiting the distance of separation to no further than an average persons handspan. As such, the user can be substantially continuously in contact with a tactile indicator, thereby providing the user with confidence that they are moving in the correct direction to reach the particular location.

Preferably the surface on which the tactile indicators are provided is any or any combination of a wall surface, handrail surface or floor surface, or mounting medium attachable to any of the aforementioned surfaces. The indicators can be provided at any or any combinations of height or position on the surface.

The suitable supporting or mounting medium can be in the form of a material which is adapted to be secured to a wall, hand rail or floor surface.

Preferably securing means for securing the mounting medium to a surface can be any or any combination of adhesive, clips, screws, nuts and bolts and/or the like.

The wall surface, handrail or floor surface are typically provided in a vehicle, building or premises and the particular location therein is typically an exit.

Preferably the tactile indicators of said first and at least second form differ in any or any combination of shape, texture, size, orientation, spatial arrangement and/or the like.

Preferably the tactile indicators are in the form of raised protrusions or indents on said surface in any suitable shape. The protrusions or indents can be embossed or moulded on the surface or suitable medium mounted on the surface.

In one embodiment the first form of tactile indicator is in the form of a tapered shape, the direction of convergence of the taper indicating the correct direction of travel to reach the particular location, or a shape having an inclined surface, the direction of the incline indicating to a user the correct direction of travel (typically the incline is from a low point to a high point relative to the surface in the direction of movement). The at least second form of tactile indicator typically has a hemispherical cross section.

Preferably the sensory part of the user's body used to follow the tactile indicators is a hand, foot, arm, leg and/or the like.

Preferably the tactile indicators are provided with illumination means to improve the visibility of the indicators to a user in low light conditions or in darkness.

The advantage of the present invention is that the tactile indicators of said at least first and second forms can be provided on the same or similar surface or mounting medium and/or provided at the same height on said surface/medium, such as waist height, thereby allowing a user to be informed of a change of direction of travel which they are required to take to reach a particular location. The user is not required to remove contact with the tactile indicators until after they have been informed of a change in the direction of travel required. This is in contrast with known guidance aids, which rely on the user having to locate guidance indicators on different mounting mediums, and physically follow the continuous line, at different heights without any prior warning that the user needs to change direction, or move away from a particular surface. In addition, there is no known guidance aid which informs a user that a change in the direction of travel is required in order to reach a particular location, and then continues to direct the person to the location.

An embodiment of the present invention will now be described below with reference to the following figures, wherein:—

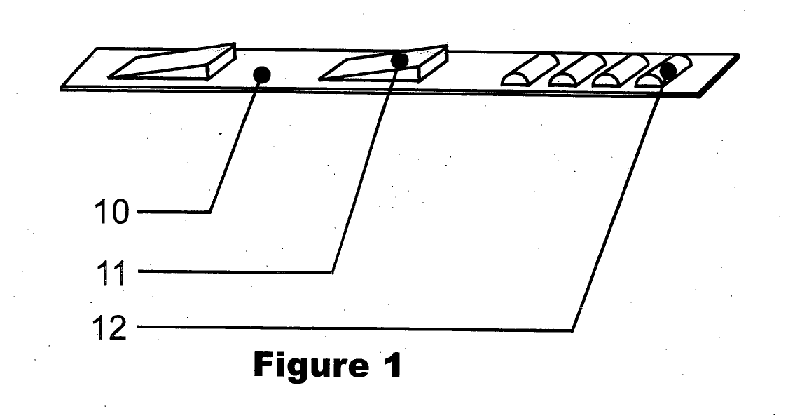

FIG. 1 shows a perspective view of tactile indicators according to an embodiment of the present invention;

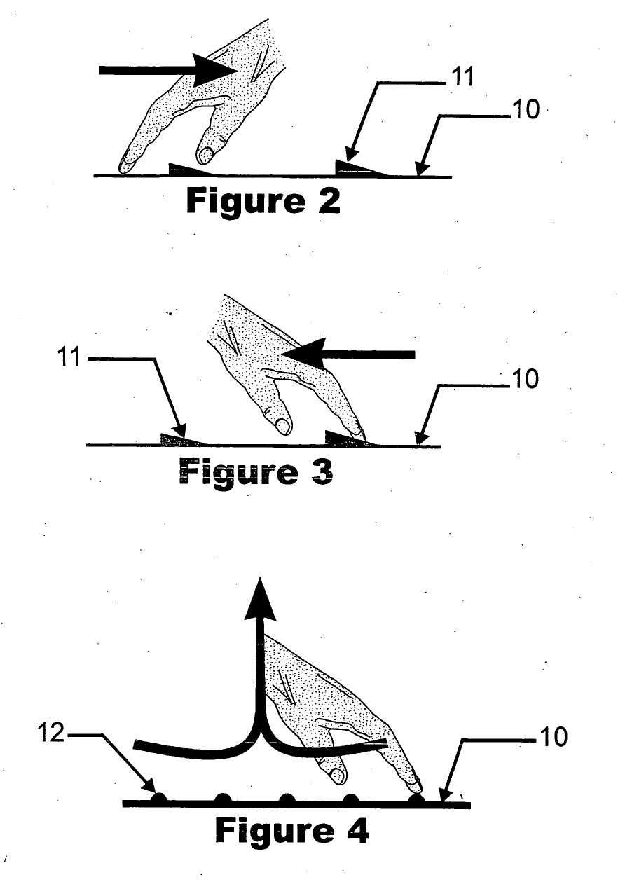

FIGS. 2 and 3 shows side views of a tactile indicator of a first form according to an embodiment of the present invention; and

FIG. 4 shows a side view of a tactile indicator of a second form for indicating a change of direction to be taken by a user.

FIG. 5.

Referring to the figures, there is illustrated a tactile guidance system 2 for guiding a user to an emergency exit in a building. The guidance system is typically provided in substantially all parts of the building to guide a user located in any part of the building to the nearest emergency exit.

The tactile guidance system is for pedestrians and disabled users (who might be in wheel chairs or small motorised disabled vehicles)-within the building and comprises first raised members 11 in the form of a sloped shape and second raised members 12 in the form of hemispherical or semi-cylindrical shapes.

The shape and/or texture of said first and second members 11, 12 respectively are clearly and easily distinguishable by a user both visually and by touch of a sensory part of a user's body, such as a hand, therewith.

The first and second members 11, 12 are provided fixed to supporting medium 10, as shown in FIG. 1. The supporting medium can then be provided on any suitable surface, such as a floor, wall, door, handrail and/or the like. The supporting medium in one example is in the form of a strip of self-adhesive vinyl which is fixed to a wall at a suitable height.

In order for a user to determine the correct direction in which they should move to reach the nearest exit, the user is required to move their hand over the first members 11. The slope of the member indicates the direction of correct travel to a user. Thus if the user moves their hand across members 11 in a direction which makes contact with an end wall 4 of the slope, as indicated by arrows 6 in FIG. 2, the end wall acts as a stop indicator, thereby informing the user that they need to move in the opposite direction. As such, the user is able to turn themselves around and follow the members 11 in the opposite direction where they can easily move their hand along the slope/incline of each member, as shown by arrow 8 in FIG. 3. In this direction, the user does not feel any impediment or barrier to their movement, thereby indicating to the user that they are travelling in the correct direction.

It is often the case that a user is required to traverse a corridor, door way or open space when moving from a location in the building to the nearest exit. In accordance with the present invention, the second members 12 are provided on supporting medium 10 which are encountered during movement of the user's hand over the medium 10 and members 11. The change of shape and/or texture of the members indicates to a user that they are required to move away from the tactile members 11, 12 in a new direction or change the direction of movement from which they were travelling in to move in a new direction, as shown by arrow 9 in FIG. 4 and FIG. 5. Once the user has changed direction and/or moved accordingly, the user continues to follow the first members 11 to the nearest exit. FIG. 5 illustrates how a user can follow a number of sets of members 11 taking a number of turns, as indicated by members 12 to reach a location 13.

For example, the distinctly different shape of member 12 indicates to a user that they must make a turn, for example through 90°, and walk forward towards an exit or more tactile directional aids/members.

The provision of a guidance aid which informs the user to make a change in the direction of travel or movement is a significant advantage as it prevents the user from becoming disorientated if the guidance members were to suddenly disappear, due to a corridor being encountered. Since the user is only likely to be using the tactile aids when there is an emergency and they are likely to be in a state of panic, it is important to provide this additional information to the user of a change in direction in order to prevent the user from wasting time looking for lost tactile aids and to keep the user as calm as possible.

The directional aids can be provided in any required shape or size sufficient to inform a user of a required direction of movement or travel. For example, the first members 11 can be square, rectangular, circular and/or the like. In addition, the first and second members are provided a pre-determined spaced distance apart to provide a substantially continuous directional aid to the user as they trace their hand along the protruding members.

The first and second members can be provided in plastic, metal or wood and can be attached to a wall surface of supporting medium by any conventional means.

The supporting medium can also be provided in plastic, metal or wood and can be fixed to a surface or detachable therefrom to allow easy removal of the medium for transport, repair and/or replacement.

1. A tactile guidance system, said tactile guidance system comprising a plurality of tactile indicators in a first form located at pre-determined spaced intervals along a side wall surface to mark a route to be followed by a user to a particular location, the user moving towards the particular location by following the tactile indicators using a sensitive part of their body, and wherein one or more tactile indicators are provided in at least a second form on said surface, the tactile indicators in said at least second form indicating to a user that they require to change their direction of movement and move in a new direction in order to reach said particular location and whereupon, having moved in said new direction, the tactile guidance system includes a further plurality of tactile indicators in the first form to allow the user to follow the same in a new direction along said route towards the particular location, said tactile indicators in a first form extend substantially continuously along said side wall surface to said particular location whereat said tactile indicators of second form are located thereby allowing the user to be in continuous contact with tactile indicators until a change of direction.

2. (canceled)

3. A system according to claim 1 wherein the tactile indicators of said first form have one or more features distinguishable from the tactile indicators of said at least second form.

4. A system according to claim 1 wherein the tactile indicators of said first and at least second form differ in any or any combination of shape, texture, size, orientation of spatial arrangement.

5. A system according to claim 1 wherein the new direction is arranged approximately 90 degrees relative to said direction of movement.

6. (canceled)

7. A system according to claim 1 wherein the tactile indicators of said first and at least second form are provided substantially continuously along the surface on the route of travel required to reach said particular location.

8. (canceled)

9. (canceled)

10. A system according to claim 1 wherein the tactile indicators are in the form of raised protrusions or indents on the surface.

11. A system according to claim 1 wherein the tactile indicator in said first form has a tapered shape, the direction of convergence of the taper indicating the direction of movement required to reach the particular location.

12. A system according to claim 1 wherein the tactile indicator in said first form has an inclined surface.

13. A system according to claim 1 wherein the tactile indicator of said second form is hemispherical in shape.

14. A system according to claim 1 wherein the sensory part of the user's body used to follow the tactile indicator is a hand.

15. (canceled)

16. A system according to claim 1 wherein the particular location is an exit of a vehicle, premises or building.

17. A method for a person to move and be guided along a first route and a second route respectively to a particular location by touching tactile indicators mounted to a support having a side wall, said tactile indicators in a first form extend substantially continuously along said side wall to said particular location whereat said tactile indicators of a second form are located thereby allowing the user to be in continuous contact with tactile indicators until a change of direction comprising the steps of:
providing first tactile indicators with said first tactile indicators each having a first configuration;
assigning a first direction of movement to said first tactile indicators;
providing a second tactile indicator with said second tactile indicator having a second configuration different from said first configuration;
assigning a second direction of movement to said second tactile indicator different from said first direction of movement;
mounting said first tactile indicators to a side wall of a support at predetermined spaced intervals to mark a first route in said first direction of movement to be followed by a person;
mounting said second tactile indicator to a side wall of a support to mark a second route in said second direction of movement to be followed by the person;
touching said first tactile indicators;
moving in said first direction of movement once one of said first tactile indicators is touched;
continuing movement in said first direction of movement past said first tactile indicators;
touching said second tactile indicator;
stopping movement in said first direction of movement once said second tactile indicator is touched;
turning away from said first direction of movement once said second tactile indicator is touched; and,
moving in said second direction of movement and touching a further series of said first tactile indicators to guide the user on said second direction of movement.

18. The method of claim 17 wherein said support is within a building and further comprising the step of:
moving adjacent said support within a building while touching said first tactile indicators and then turning and exiting said building when said second tactile indicator is touched.

19. The method of claim 18 and comprising the further step of:
exiting the building after completion of the step of moving in said second direction of movement.

20. The method of claim 19 and further comprising the step of providing a continuous surface and wherein said steps of touching said first tactile indicators and said second tactile indicator includes moving adjacent said surface.

21. A method for a person to move and be guided along a route by touching tactile indicators affixed to a suitable supporting medium comprising the steps of:
providing a first set of raised or indented distinctively shaped or textured features;
assigning a first direction of movement to said first distinctive features according to the least resistance when said first features are tactilely interrogated;
providing a second set of raised or indented distinctively shaped or textured features, said second features being distinctive in shape or texture to said first features;
assigning a change in direction of movement to said second features different from said first direction of movement;
affixing said first features to a suitable supporting medium to mark a first route in said first direction of movement to be followed by a person;
affixing said second features to a suitable supporting medium to mark a change in direction away from said second features;
touching said first features;
moving in said first direction of movement once one of said first features is touched;
continuing movement in said first direction of movement past further said first features;
touching said second feature;
stopping movement in said first direction of movement once said second feature is touched;
moving away from said second features in said second direction of movement once said second feature is touched;
characterised in that a series of said first shaped features and a series of said second shaped features are arranged in separate distinct groups in a linear manner such that a series of the first shaped features are positioned prior to and/or following a group of said second shaped features.
